(19) United States
(12) Patent Application Publication
(10) Pub. No.: US 2026/0047551 A1
(43) Pub. Date: Feb. 19, 2026

(54) Pet Nail Rounder and Smoother Device

(71) Applicant: Samanvitha Koduvayur Suresh, Middleton, WI (US)

(72) Inventor: Samanvitha Koduvayur Suresh, Middleton, WI (US)

(21) Appl. No.: 19/291,705

(22) Filed: Aug. 6, 2025

Related U.S. Application Data
(60) Provisional application No. 63/682,384, filed on Aug. 13, 2024.

(51) Int. Cl. A01K 13/00; A45D 29/05

(52) U.S. Cl. CPC A01K 13/00; A45D 29/05

(57) ABSTRACT

A pet nail filer device is disclosed, which is a nail rounder and smoother that can be applied to dogs, cats, rabbits, guineapigs, birds and other pet animals, etc., as needed. The pet nail filer device comprises a base component that is configured in a small, ergonomic, rounded cuboidal shape that is sized and shaped to be held in a palm of a user's hand with a hinged lid component. An interchangeable nail file component is releasably secured to the base component. The interchangeable nail file component is shaped like a small cup to fit an individual pet nail. The interchangeable nail file component comprises sandpaper like grit material within the cup cavity to safely file away the pet's nail. The interchangeable nail file component comes in a range of sizes and working mechanisms, ensuring that pet owners and groomers can find the perfect fit for their current animal.

### CROSS-REFERENCE TO RELATED APPLICATION

The present application claims priority to, and the benefit of, U.S. Provisional Application No. 63/682,384, which was filed on Aug. 13, 2024, and is incorporated herein by reference in its entirety.

### FIELD OF THE INVENTION

The present invention relates generally to the field of pet nail filer devices. More specifically, the present invention relates to a nail rounder and smoother that can be applied to dogs, cats, rabbits, guineapigs, birds and other pet animals. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in pet nail filer devices. Generally, animal nails can grow quickly and require frequent clipping. This means frequent trips to the pet groomers or spending a lot of time trying to do it yourself. Also, clipping the nails always leaves the nail sharp and we get seriously scratched by our pet's sharp clipped nails which can even cause bleeding. So once clipping is done, we need to spend more time trying to file, which is hard to get a well-rounded and perfectly smooth nail, plus it costs more. Further, pet animals may be fearful of nail clippers and have anxiety associated with getting their nails clipped and filed and when more steps are involved in the process, the more anxious the pets can get. Also, disposing the clipped nail bits safely is an additional chore for the person operating the nail clippers, and the clipped nail pieces can be a choking hazard for the animals and also children. Additionally, manual files can take too long, and existing motorized files (Dremel) can go too fast and end up filing away too much of the nail and causing injury.

It is desirable to trim the nails of pet animals which are kept indoors. Trimming of the nails is important to prevent the nails from being caught on cages and other accessories which may cause injury. However, clippers can be used to trim and cut nails but are dangerous and risk injury to both the person operating the tool and the animal, due to the unpredictability of the animal's response. As a result, the nails of pet animals are sometimes over trimmed causing bleeding or other possible discomfort to the animal. Accordingly, it would be desirable to provide a device which would effectively trim the nails of pet animals without providing discomfort to the animal. Accordingly, a need exists for a product which conveniently and safely holds in place an animal's nail, claw or other appendage while gently dulling the nail's sharpness and length.

Accordingly, there is a demand for an improved pet nail filer device that provides a nail rounder and smoother for dogs, cats, rabbits, guineapigs, birds and other pet animals. More particularly, there is a demand for a pet nail filer device that enables pet owners to safely and quickly file a pets' nails.

Therefore, there exists a long-felt need in the art for a pet nail filer device that provides users with a nail rounder and smoother that can be applied to dogs, cats, rabbits, guineapigs, birds and other pet animals, etc. There is also a long-felt need in the art for a pet nail filer device that resembles a small cup and features a rotating sandpaper grit mechanism that can be interchanged underneath a hinged lid for safety, allowing users to reveal the mechanism and file a pet's nails. Further, there is a long-felt need in the art for a pet nail filer device that enables a pet owner or groomer to place their pet's nails inside the filer and easily control the device to safely file the nail. Moreover, there is a long-felt need in the art for a device that utilized batteries to power the device that can be easily replaced or recharged as needed. There is also a long-felt need in the art for a pet nail filer device that utilizes sound absorbing materials which operates significantly quieter. Further, there is a long-felt need in the art for a pet nail filer device that offer a way for all pet owners and groomers to file animal nails without any training and in a fraction of the time. Finally, there is a long-felt need in the art for a pet nail filer device that utilizes an appropriate speed to ensure the nail is filed gently without giving a pet anxiety.

The subject matter disclosed and claimed herein, in one embodiment thereof, comprises a pet nail filer device. The device is a nail rounder and smoother that can be applied to dogs, cats, rabbits, guineapigs, birds and other pet animals, etc., as needed. The pet nail filer device comprises a base component that is configured in a small, ergonomic, rounded cuboidal shape that is sized and shaped to be held in a palm of a user's hand with a hinged lid component. An interchangeable nail file component is releasably secured to the base component. The interchangeable nail file component is shaped like a small cup to fit an individual pet nail. The interchangeable nail file component comprises sandpaper like grit material within the cup cavity to safely file away the pet's nail. The interchangeable nail file component comes in a range of sizes and working mechanisms, ensuring that pet owners and groomers can find the perfect fit for their current animal. The device is battery-operated with replaceable or rechargeable batteries. The base component further comprises a motor, battery, and any suitable wiring for allowing the interchangeable nail file component to rotate around the pet's inserted nail to nicely round, smooth, and reduce the length of the pet nail all at once via the sandpaper like grit material. Further, the motor acts to rotate the nail file component at an appropriate speed to ensure the pet nail is filed gently, without giving a pet anxiety. The base component can be made of soft silicone material to enhance grip and comfort. There is also an ergonomic button on the side to activate the motor upon being pressed. The device is also made with sound absorbing material which significantly reduces the sound of the device while operating which can help to keep the pet animal calm.

In this manner, the pet nail filer device of the present invention accomplishes all of the forgoing objectives and provides users with a device that provides a nail rounder and smoother device that is applied to pet animals. The device functions as a small, motorized nail file. The device is ergonomic in shape and size.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a pet nail filer device. The pet nail filer device comprises a base component that is configured to be held in a palm of a user's hand. An interchangeable nail file component, shaped like a small cup to retain a pet's nails, is releasably secured to the base component. The interchangeable nail file component comprises sandpaper like grit material within the cup cavity to safely file away the pet's nails. Further, the motor acts to rotate the nail file component at an appropriate speed to ensure the pet nail is filed gently, without giving a pet anxiety.

In one embodiment, the pet nail filer device is a nail rounder and smoother that can be applied to dogs, cats, rabbits, guineapigs, birds and other pet animals, etc., as needed. The device functions like a small, motorized nail file. The pet nail filer device enables a pet owner or groomer to place their pet's nail inside the filer and easily control the device to safely file the nail. Further, the device offers a way for all pet owners and groomers to file animal nails without any training and in a fraction of the time.

In one embodiment, the pet nail filer device comprises an interchangeable nail file component, which is releasably secured to a boss of the base component. The interchangeable nail file component is shaped like a small cup to fit an individual pet nail. Specifically, the interchangeable nail file component is in the shape of a concave cup, with the intention that it would keep the pet's nail within the cup structure and prevent the pet's nail from slipping off and/or causing an injury. Thus, the concave cup would gently but securely hold in place the nail of a dog, cat, rabbit, guineapig, bird or other pet, while it smooths and rounds the tip and outer surface layers of the nails, the extent of which is determined by the user and customizable for the pet. Such a component has the further benefit of creating a smooth complete finish of the nails and provides a level of comfort to both owner and pet. Specifically, the interchangeable nail file component is shaped in a cylindrical configuration, with an interior cavity. The nail file component comprises a top opening and a bottom surface with a curved, cylindrical sidewall positioned therebetween. The top opening allows access to the interior cavity and the bottom surface comprises a keyed stem or protrusion to be positioned in the boss of the base component and secured via twisting the nail file component left or right. The nail file component can then be released via twisting in the opposite direction. In one embodiment, the base component comprises a release button, which is used to release the interchangeable nail file component from the boss of the base component. Further, the interior cavity comprises a sandpaper like grit material to safely file away the pet's nails. Additionally, the interchangeable nail file component comes in a range of sizes, ensuring that pet owners and groomers can find the perfect fit for their current animal. The sandpaper like grit material is configured to trim, smooth or file an animal's nails when the interchangeable nail file component is oscillated about an axis. Further, the sandpaper like grit material includes an abrasive surface, such as sanding paper, an emery board, or other abrasive compound.

In one embodiment, the interchangeable nail file component is driven by an electric drive device, such as a motor. In one embodiment, the rotating action is driven by a motor of appropriate speed and torque, that allows for the rotation of the interchangeable nail file component. Further, the interchangeable nail file component is rotated at an appropriate speed, typically an appropriate speed so as not to cause anxiety to the pet, during use. Typically, the interchangeable nail file component rotates at a generally appropriate speed. The smoothing and rounding of the pet nails will occur by virtue of the rotation of the interchangeable nail file component. The rotations per minute (“RPM”) and/or the direction of the rotation will vary depending on the type and size of the animal, the length and thickness of the nails, and the nature of the filing action required. Specifically, the RPM can be decreased for a slower grooming process, which may be less intimidating to smaller and/or more easily excitable animals. Furthermore, the ability to alternate the rotational direction would accommodate various circumstances, including particular needs of the animal and/or injuries or sensitivities. In one embodiment, the speed of the motor and rotational direction is controlled by a controller in communication with the motor. Further, an additional button can be utilized on the base component to allow a user to control the motor's speed and rotational direction.

In one embodiment, the motor is powered by a battery. The battery is either replaceable or rechargeable. Specifically, the bottom surface of the base component comprises a battery cavity for securing a plurality of replaceable/rechargeable batteries. Thus, the device is a battery powered or corded device. Accordingly, if replaceable, the batteries can be replaced as needed. If rechargeable, the batteries can be charged via a USB port.

In one embodiment, the pet nail filer device includes a base component which is of dimensions and weight capable of comfortable use as a handheld tool. Thus, the base component is configured in a small, ergonomic, rounded cuboidal shape that is sized and shaped to be held in a user's hand with a hinged lid component. Specifically, the base component can be any suitable shape and size as is known in the art, as long as its shaped and sized to fit within the palm of the user's hand. The base component comprises a top surface, a bottom surface, opposing sidewalls, and opposing front and back walls. The top surface comprises a boss or other means for retaining an interchangeable nail file component. Further, a hinged lid component connected via hinges at a top of a sidewall acts to enclose the top surface and boss when not in use.

In one embodiment, the base component can be manufactured of a soft, silicone material or a soft urethane, polyethylene, polystyrene material, etc., to enhance grip and comfort. This soft material allows a user to easily squeeze and grip the device in their hands during use.

In one embodiment, at least one of the sidewalls of the base component comprises a plurality of ergonomic finger grooves or other indentations which allow a user to grip, squeeze, and maneuver the device, as needed during use.

In one embodiment, the base component comprises a side button on the exterior surface of the base component. The side button is a power switch and is pressed to turn on and off the motor. Specifically, the side button is a pressure switch, such that when pressed and held down by a user, the motor turns on or starts. Then, when a user lets go of the side button, the motor turns off. Alternatively, the device can be controlled with a switch that can be turned on or off when needed without needing to press continuously.

In yet another embodiment, the pet nail filer device comprises a plurality of indicia.

In yet another embodiment, a method of rounding and smoothing a pet's nails without causing pet anxiety is disclosed. The method includes the steps of providing a pet nail filer device comprising a base component with an interchangeable nail file component. The method also comprises selecting a specifically sized interchangeable nail file component and securing it to the base component for use. Further, the method comprises holding the base component in a palm of a hand, so a user can reach a side button. The method also comprises inserting a pet's nail into the desired interchangeable nail file component. The method also comprises pressing the side button to rotate the interchangeable nail file component to round and smooth the pet's nail. Finally, the method comprises releasing the side button when done and removing the pet's nail from the interchangeable nail file component.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIGS. 1A-B illustrate a perspective view of one embodiment of the pet nail filer device of the present invention showing the base component and how the hinged lid component opens in accordance with the disclosed architecture;

FIG. 2 illustrates a perspective view of one embodiment of the pet nail filer device of the present invention showing the interchangeable nail file components in accordance with the disclosed architecture;

FIGS. 3A-C illustrate a perspective view of one embodiment of the pet nail filer device of the present invention showing the batteries of the device and how it starts and stops when pressing the side button in accordance with the disclosed architecture;

FIG. 4 illustrates a perspective view of one embodiment of the pet nail filer device of the present invention showing the device in use on a variety of pet animals in accordance with the disclosed architecture;

FIGS. 5A-B illustrate a perspective view of one embodiment of the pet nail filer device of the present invention showing a pet's nails before and after use of the device in accordance with the disclosed architecture; and

FIG. 6 illustrates a flowchart showing the method of rounding and smoothing a pet's nails without causing pet anxiety in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a pet nail filer device that provides users with a nail rounder and smoother that can be applied to dogs, cats, rabbits, guineapigs, birds and other pet animals, etc. There is also a long-felt need in the art for a pet nail filer device that resembles a small cup and features a rotating sandpaper grit mechanism that can be interchanged underneath a hinged lid for safety, allowing users to reveal the mechanism and file a pet's nails. Further, there is a long-felt need in the art for a pet nail filer device that enables a pet owner or groomer to place their pet's nails inside the filer and easily control the device to safely file the nail. Moreover, there is a long-felt need in the art for a device that utilized batteries to power the device that can be easily replaced or recharged as needed. Further, there is a long-felt need in the art for a pet nail filer device that offer a way for all pet owners and groomers to file animal nails without any training and in a fraction of the time. Finally, there is a long-felt need in the art for a pet nail filer device that utilizes an appropriate speed to ensure the nail is filed gently without giving a pet anxiety.

The present invention, in one exemplary embodiment, is a novel pet nail filer device. The pet nail filer device comprises a base component that is configured in a small, ergonomic, rounded cuboidal shape that is sized and shaped to be held in a palm of a user's hand with a hinged lid component. An interchangeable nail file component is releasably secured to the base component. The interchangeable nail file component is shaped like a small cup to fit an individual pet nail and comprises sandpaper like grit material to safely file away the pet's nail. The device is battery-operated with replaceable or rechargeable batteries. The base component further comprises a motor, battery, and any suitable wiring for allowing the interchangeable nail file component to rotate around the pet's inserted nail.

The present invention also includes a novel method of rounding and smoothing a pet's nails without causing pet anxiety. The method includes the steps of providing a pet nail filer device comprising a base component with an interchangeable nail file component. The method also comprises selecting a specifically sized interchangeable nail file component and securing it to the base component for use. Further, the method comprises holding the base component in a palm of a hand, so a user can reach a side button. The method also comprises inserting a pet's nail into the desired interchangeable nail file component. The method also comprises pressing the side button to rotate the interchangeable nail file component to round and smooth the pet's nail. Finally, the method comprises releasing the side button when done and removing the pet's nail from the interchangeable nail file component.

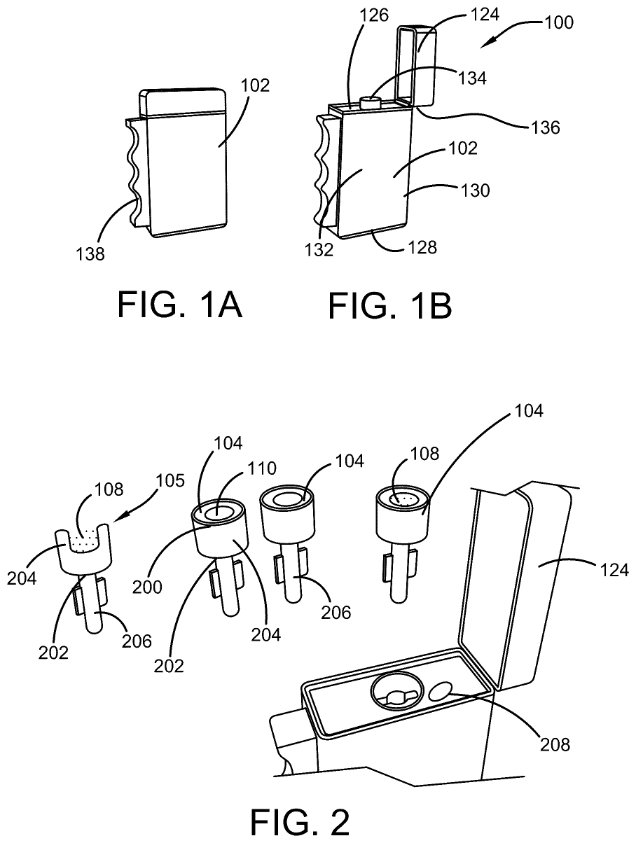

Referring initially to the drawings, FIGS. 1A-B illustrate a perspective view of one embodiment of the pet nail filer device 100 of the present invention. In the present embodiment, the pet nail filer device 100 is an improved pet nail filer device 100 that provides a user 118 with a small, motorized nail file configured to be held in a palm 120 of a user's hand 122. Specifically, the pet nail filer device 100 comprises a base component 102 and an interchangeable nail file component 104, shaped like a small cup to retain a pet's nail 106. The interchangeable nail file component 104 comprises sandpaper like grit material 108 within the cup cavity 110 to safely file away the pet's nails 106. Further, the motor 114 acts to rotate the nail file component 104 at an appropriate speed to ensure the pet nail 106 is filed gently, without giving a pet 116 anxiety.

Generally, the pet nail filer device 100 is a nail rounder and smoother that can be applied to dogs, cats, rabbits, guineapigs, birds and other pet animals or pets 116, etc., as needed. The device 100 functions like a small, motorized nail file. The pet nail filer device 100 enables a pet owner or groomer to place their pet's nails 106 inside the filer and easily control the device 100 to safely file the nails 106. Further, the device 100 offers a way for all pet owners and groomers to file animal nails 106 without any training and in a fraction of the time.

Furthermore, the pet nail filer device 100 includes a base component 102 which is of dimensions and weight capable of comfortable use as a handheld tool. Thus, the base component 102 is configured in a small, ergonomic, rounded cuboidal shape that is sized and shaped to be held in a user's hand 122 with a hinged lid component 124. Specifically, the base component 102 can be any suitable shape and size as is known in the art, as long as its shaped and sized to fit within the palm 120 of the user's hand 122. The base component 102 comprises a top surface 126, a bottom surface 128, opposing sidewalls 130, and opposing front and back walls 132. The top surface 126 comprises a boss 134 or other means for retaining an interchangeable nail file component 104. Further, a hinged lid component 124 connected via hinges 136 at a top of a sidewall 130 acts to enclose the top surface 126 and boss 134 when not in use.

Additionally, the base component 102 can be manufactured of a soft, silicone material or a soft urethane, polyethylene, polystyrene material, etc., to enhance grip and comfort. This soft material allows a user 118 to easily squeeze and grip the device 100 in their hands 122 during use.

Further, at least one of the sidewalls 130 of the base component 102 comprises a plurality of ergonomic finger grooves 138 or other indentations which allow a user 118 to grip, squeeze, and maneuver the device 100, as needed during use.

As shown in FIG. 2, the pet nail filer device 100 comprises an interchangeable nail file component 104, which is releasably secured to a boss 134 of the base component 102. The interchangeable nail file component 104 is shaped like a small cup to fit an individual pet nail106. Specifically, the interchangeable nail file component 104 is in the shape of a concave cup, with the intention that it would keep the pet's nail 106 within the cup structure and prevent the pet's nail 106 from slipping off and/or causing an injury. Thus, the concave cup would gently but securely hold in place the nail 106 of a dog, cat, rabbit, guineapig, bird, or other pet 116, while it smooths and rounds the tip and outer surface layers of the nails 106, the extent of which is determined by the user 118 and customizable for the pet 116. Such a component 104 has the further benefit of creating a smooth complete finish of the nails 106 and provides a level of comfort to both owner and pet 116. Specifically, the interchangeable nail file component 104 is shaped in a cylindrical configuration, with an interior cavity 110. The nail file component 104 comprises a top opening 200 and a bottom surface 202 with a curved, cylindrical sidewall 204 positioned therebetween. The top opening 200 allows access to the interior cavity 110 and the bottom surface 202 comprises a keyed stem 206 or protrusion to be positioned in the boss 134 of the base component 102 and secured via twisting the nail file component 104 left or right. The nail file component 104 can then be released via twisting in the opposite direction. In one embodiment, the base component 102 comprises a release button 208, which is used to release the interchangeable nail file component 104 from the boss 134 of the base component 102. Further, the interior cavity 110 comprises a sandpaper like grit material 108 to safely file away the pet's nails 106. Additionally, the interchangeable nail file component 104 comes in a range of sizes, ensuring that pet owners and groomers can find the perfect fit for their current animal. The sandpaper like grit material 108 is configured to trim, smooth or file an animal's nails 106 when the interchangeable nail file component 104 is rotated about an axis. Further, the sandpaper like grit material 108 includes an abrasive surface, such as sanding paper, an emery board, or other abrasive compound.

In one embodiment, the nail file component 104 is an expanding and shrinking nail head component 105 which will automatically adjust its size based on the pet's nail size. This nail head component 105 would comprise any suitable elastic grit material that expands and contracts based on the pet's nail size and acts to smooth and round the pet nail. In another embodiment, the expanding and shrinking nail head component 105 includes a means which allows the head component 105 to open and close to fit around any pet's nail size.

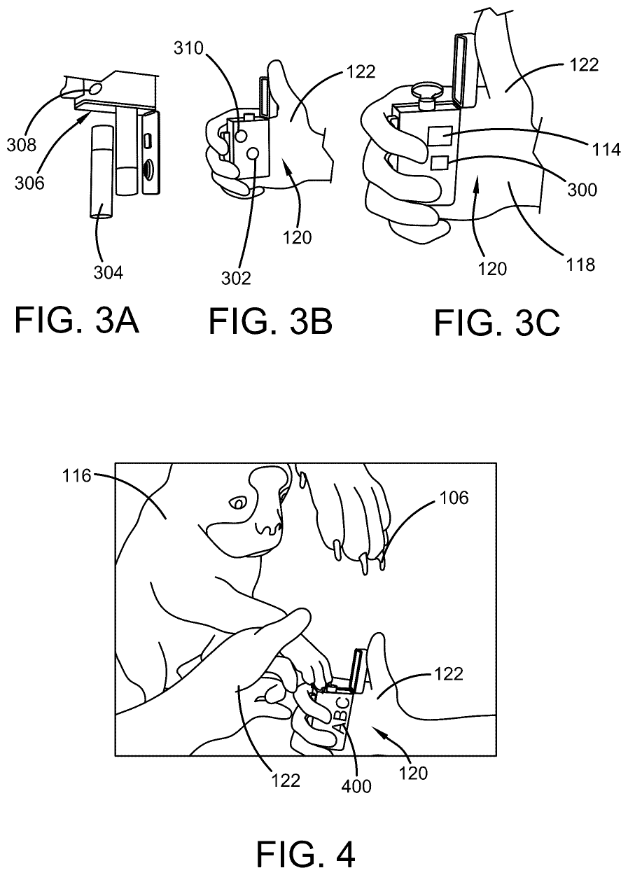

As shown in FIGS. 3A-C, the interchangeable nail file component 104 and expanding and shrinking nail head component 105 is driven by an electric drive device, such as a motor 114. In one embodiment, the rotating action is driven by a motor 114 of appropriate speed and torque, that allows for the rotation of the interchangeable nail file component 104 and nail head component 105. Further, the interchangeable nail file component 104 and 105 is rotated at an appropriate speed, typically an appropriate speed so as not to cause anxiety to the pet 116, during use. Typically, the interchangeable nail file component 104 and 105 rotates at a generally appropriate speed. The smoothing and rounding of the pet nails 106 will occur by virtue of the rotation of the interchangeable nail file component 104 and 105. The rotations per minute (“RPM”) and/or the direction of the rotation will vary depending on the type and size of the animal, the length and thickness of the nails 106, and the nature of the filing action required. Specifically, the RPM can be decreased for a slower grooming process, which may be less intimidating to smaller and/or more easily excitable animals 116. Furthermore, the ability to alternate the rotational direction would accommodate various circumstances, including particular needs of the animal 116 and/or injuries or sensitivities. In one embodiment, the speed of the motor 114 and rotational direction is controlled by a controller 300 in communication with the motor 114. Further, an additional button 302 can be utilized on the base component 102 to allow a user 118 to control the motor's speed and rotational direction.

Further, the motor 114 is powered by a battery 304. The battery 304 is either replaceable or rechargeable. Specifically, the bottom surface 128 of the base component 102 comprises a battery cavity 306 for securing a plurality of replaceable/rechargeable batteries 304. Thus, the device 100 is a battery powered or corded device. Accordingly, if replaceable, the batteries 304 can be replaced as needed. If rechargeable, the batteries 304 can be charged via a USB port 308.

Additionally, the base component 102 comprises a side button 310 on the exterior surface of the base component 102. The side button 310 is a power switch and is pressed to turn on and off the motor 114. Specifically, the side button 310 is a pressure switch, such that when pressed and held down by a user 118, the motor 114 turns on or starts. Then, when a user 118 let's go of the side button 310, the motor 114 turns off. Alternatively, the device can be controlled with a switch that can be turned on or off when needed without needing to press continuously.

As shown in FIG. 4, in yet another embodiment, the pet nail filer device 100 comprises a plurality of indicia 400. The base component 102 of the device 100 may include advertising, a trademark, or other letters, designs, or characters, printed, painted, stamped, or integrated into the base component 102, or any other indicia 400 as is known in the art. Specifically, any suitable indicia 400 as is known in the art can be included, such as but not limited to, patterns, logos, emblems, images, symbols, designs, letters, words, characters, animals, advertisements, brands, etc., that may or may not be pets, nails, or brand related.

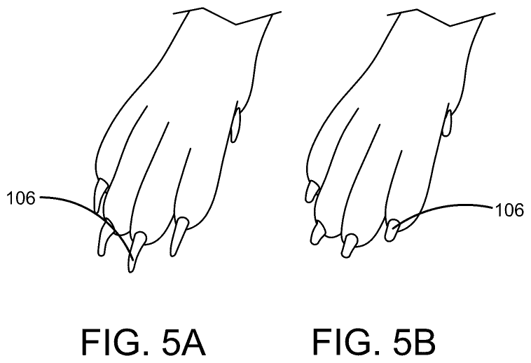

As shown in FIGS. 5A-B, in operation, a user 118 inserts one pet nail 106 or nail 106 at a time into the interchangeable nail file component 104. Then, a user 118 presses the side button 310 for a few seconds, releases the button 310 and checks the pet nail 106 and repeats, as required.

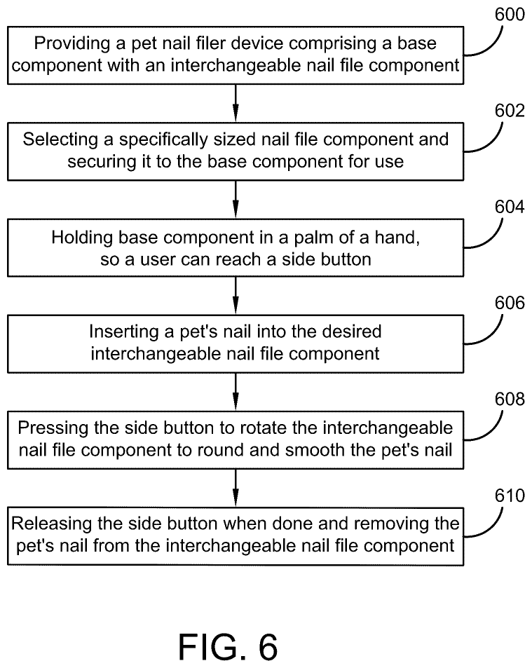

FIG. 6 illustrates a flowchart of the method of rounding and smoothing a pet's nails without causing pet anxiety. The method includes the steps of at 600, providing a pet nail filer device comprising a base component with an interchangeable nail file component. The method also comprises at 602, selecting a specifically sized interchangeable nail file component and securing it to the base component for use. Further, the method comprises at 604, holding the base component in a palm of a hand, so a user can reach a side button. The method also comprises at 606, inserting a pet's nail into the desired interchangeable nail file component. The method also comprises at 608, pressing the side button to rotate the interchangeable nail file component to round and smooth the pet's nail. Finally, the method comprises at 610, releasing the side button when done and removing the pet's nail from the interchangeable nail file component.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “pet nail filer device”, “nail filer device”, “pet device”, and “device” are interchangeable and refer to the pet nail filer device 100 of the present invention.

Notwithstanding the forgoing, the pet nail filer device 100 of the present invention can be of any suitable size and configuration as is known in the art without affecting the overall concept of the invention, provided that it accomplishes the above stated objectives. One of ordinary skill in the art will appreciate that the pet nail filer device 100 as shown in FIGS. 1-6 is for illustrative purposes only, and that many other sizes and shapes of the pet nail filer device 100 are well within the scope of the present disclosure. Although the dimensions of the pet nail filer device 100 are important design parameters for user convenience, the pet nail filer device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A pet nail filer device that provides a user with a motorized nail file configured for a pet animal, the pet nail filer device comprising:
a base component; and
an interchangeable nail file component;
wherein the interchangeable nail file component comprises sandpaper like grit material and is configured for insertion of a pet's nail;
wherein the base component includes a motor for rotating the interchangeable nail file component to smooth and round a pet's nails; and
further wherein the motor acts to rotate the interchangeable nail file component at an appropriate speed to ensure the pet's nails are filed gently.

2. The pet nail filer device of claim 1, wherein the base component is configured in a small, ergonomic, rounded cuboidal shape that is sized and shaped to be held in a user's hand.

3. The pet nail filer device of claim 2, wherein the base component comprises a top surface, a bottom surface, opposing sidewalls, and opposing front and back walls.

4. The pet nail filer device of claim 3, wherein the top surface comprises a boss for retaining the interchangeable nail file component.

5. The pet nail filer device of claim 4, wherein the base component comprises a hinged lid component connected via hinges to a top of a sidewall, to enclose the top surface and boss when not in use.

6. The pet nail filer device of claim 5, wherein the base component can be manufactured of a soft, silicone material or a soft urethane, polyethylene, or polystyrene material to enhance grip and comfort.

7. The pet nail filer device of claim 6, wherein at least one of the sidewalls of the base component comprises a plurality of ergonomic finger grooves for a user to grip.

8. The pet nail filer device of claim 7, wherein the interchangeable nail file component is shaped in a cylindrical configuration, with an interior cavity.

9. The pet nail filer device of claim 8, wherein the interchangeable nail file component comprises a top opening and a bottom surface with a curved, cylindrical sidewall positioned therebetween.

10. The pet nail filer device of claim 9, wherein the top opening allows access to the interior cavity and the bottom surface comprises a keyed stem to be positioned in the boss of the base component and secured via twisting the interchangeable nail file component left or right.

11. The pet nail filer device of claim 10, wherein the interchangeable nail file component can then be released via twisting in an opposite direction.

12. The pet nail filer device of claim 11, wherein the interchangeable nail file component comes in a range of sizes and working mechanisms, ensuring that pet owners and groomers can find a perfect fit for their current animal.

13. The pet nail filer device of claim 12, wherein the base component comprises a controller in communication with the motor to control a motor's speed and rotational direction.

14. The pet nail filer device of claim 13, wherein the motor is powered by a replaceable or rechargeable battery.

15. The pet nail filer device of claim 14, wherein the base component comprises a side button, which is a pressure switch, such that when pressed and held down by a user, the motor turns on or starts, then, when a user lets go of the side button, the motor turns off.

16. A pet nail filer device that provides a user with a motorized nail file configured for a pet animal, the pet nail filer device comprising:
a base component comprising a top surface, a bottom surface, opposing sidewalls, and opposing front and back walls; and
an expanding and shrinking nail head component which automatically adjusts its size based on a pet's nail size;
wherein the expanding and shrinking nail head component comprises sandpaper like grit material and is configured for insertion of a pet's nail;
wherein the top surface comprises a boss for retaining the expanding and shrinking nail head component;
wherein the base component comprises a hinged lid component connected via hinges to a top of a sidewall, to enclose the top surface and boss when not in use;
wherein a top opening of the expanding and shrinking nail head component allows access to an interior cavity and the bottom surface comprises a keyed stem to be positioned in the boss of the base component and secured via twisting the expanding and shrinking nail head component left or right;
wherein the base component includes a motor for rotating the expanding and shrinking nail head component to smooth and round a pet's nails;
wherein the motor acts to rotate the expanding and shrinking nail head component at an appropriate speed to ensure the pet's nails are filed gently, without giving a pet anxiety;
wherein the motor is powered by a replaceable or rechargeable battery; and
further wherein the base component comprises a side button, which is a pressure switch, such that when pressed and held down by a user, the motor turns on or starts, then, when a user lets go of the side button, the motor turns off.

17. The pet nail filer device of claim 16, wherein if rechargeable, the batteries can be charged via a USB port.

18. The pet nail filer device of claim 16, wherein if replaceable, the batteries can be replaced, as needed.

19. The pet nail filer device of claim 16 further comprising a plurality of indicia.

20. A method of rounding and smoothing a pet's nails without causing pet anxiety, the method comprising the following steps:
providing a pet nail filer device comprising a base component with an interchangeable nail file component;
selecting a specifically sized interchangeable nail file component and securing it to the base component for use;
holding the base component in a palm of a hand, so a user can reach a side button;
inserting a pet's nail into the desired interchangeable nail file component;
pressing the side button to rotate the interchangeable nail file component to round and smooth the pet's nail; and
releasing the side button when done and removing the pet's nail from the interchangeable nail file component.
